(19) United States
(12) Patent Application Publication
(10) Pub. No.: US 2010/0207331 A1
(43) Pub. Date: Aug. 19, 2010

(54) BIODEGRADABLE TARGET DISC AND METHODS OF MAKING THE SAME

(76) Inventors: Adrian Boeh, Lafayette, IN (US); Benjamin Hall, Fort Wayne, IN (US); Gary John Mullen, N. Hollywood, CA (US); David Robert Conway, Edgewater, NJ (US); Osvaldo H. Campanella, West Lafayette, IN (US)

Correspondence Address: BOSE MCKINNEY & EVANS LLP, 111 MONUMENT CIRCLE, SUITE 2700, INDIANAPOLIS, IN, 46204, US

(21) Appl. No.: 12/707,232

(22) Filed: Feb. 17, 2010

Related U.S. Application Data
(60) Provisional application No. 61/153,121, filed on Feb. 17, 2009.

(51) Int. Cl. F41J 9/16; B29C 39/38

(52) U.S. Cl. 273/362; 264/330

(57) ABSTRACT

A biodegradable target disc adapted to be molded into a rigid target that is launchable from a launching device, the biodegradable target disc comprising soy protein isolate and protein filler.

### RELATED APPLICATIONS

This application claims the benefit of U.S. Provisional Patent Application Ser. No. 61/153,121, filed Feb. 17, 2009, the complete disclosure of which is expressly incorporated herein by this reference.

### FIELD OF THE INVENTION

The present invention relates generally to biodegradable target discs, and particularly, soy-based biodegradable target discs and methods of making the same.

### BACKGROUND OF THE INVENTION

Hunting animals for food, recreation and/or trade has been a very popular practice for many years. Since many animals are small and capable of quick movement, successful hunters must be able to aim and shoot at these targets with extreme precision and accuracy. To develop these skills, many hunters practice by shooting at artificial targets. These artificial targets are propelled into the air, and then the shooter attempts to strike them before they hit the ground. To visually determine if these artificial targets have been struck by the shooter, the targets are usually composed of materials that break apart into a visible cloud of dust upon impact. Historically, these targets have been manufactured from a mixture of clay and/or dolomitic limestone, petroleum pitch and fluorescent paint. While targets manufactured from these ingredients typically break apart as desired, they unfortunately are difficult to decompose once exposed to the outside environment. As such, the landscape surrounding the shooting facility is often left littered with materials that not only take a long time to break down, but may even cause permanent ecological stress and damage to the surrounding environment.

Some companies have attempted to make biodegradable targets; however, studies suggest that many of these targets still take several years to fully decompose. In addition, the surrounding soil is often acidified as these targets decompose, which in turn can cause irreparable damage to the environment.

The present invention is intended to address and/or to improve upon one or more of the problems discussed above.

### SUMMARY OF THE INVENTION

The present invention is generally related to biodegradable soy-based target discs having a filler material that is composed of soybean meal and a binder material, the binder material including soy protein glue.

According to one aspect of the present invention, a biodegradable target disc is provided. The biodegradable target disc comprises soy protein isolate and protein filler. The target disc is adapted to be molded into a rigid target that is launchable from a launching device.

According to another aspect of the present invention, a method for manufacturing a biodegradable target disc is provided. The method comprises forming a mixture containing soy protein isolate, water and an acidic solution, extracting an acidified soy protein suspension from the mixture, adding a protein filler to the acidified soy protein suspension to form a dough, pouring the dough into a mold, heating the dough inside the mold to form a rigid target disc, and removing the rigid target disc from the mold.

According to yet still another aspect of the present invention, a biodegradable target disc adapted to be molded into a rigid target that is launchable from a launching device is provided. The biodegradable target disc comprises a binder material formed from a mixture of soy protein isolate, water and vinegar, and a protein filler including soybean meal. The ratio of the binder material to the protein filler is about 1:1.

### DETAILED DESCRIPTION

The embodiments of the present invention described below are not intended to be exhaustive or to limit the invention to the precise forms disclosed in the following detailed description. Rather, the embodiments are chosen and described so that others skilled in the art may appreciate and understand the principles and practices of the present invention.

Unlike most conventional discs or clay pigeons manufactured for recreational target practice, the discs of the present invention can be manufactured from 100% biodegradable ingredients, which in turn do not negatively impact the surrounding environment. This is in direct contrast to most conventional discs, which are composed of non-biodegradable materials, such as petroleum pitch and chalk, dolomitic limestone and fluorescent paint. As these ingredients are unable to rapidly decompose, they can cause ecologic stress to the surrounding environment when exposed thereto. Advantages and improvements of these inventive discs, as well as the processes and methods of making the same, are demonstrated in the following descriptive embodiments provided below. These embodiments are illustrative only and are not intended to limit or preclude other variants or aspects of the present invention.

In certain aspects of the present invention, approximately 120 mL of water is placed in a 500 mL beaker together with a magnetic stir rod/bar. The beaker is placed on a heating/stir plate, and the heating/stir plate is activated to commence stirring of the water. It should be understood and appreciated that heating the water decreases the amount of time needed to form the end products, particularly as increasing the water temperature generally causes the associated chemical reactions described herein to be expedited. As such, in certain embodiments the water can be left unheated if it is desirable to slow down or control the rate at which the associated chemical reactions are achieved.

In embodiments in which the water is heated, it is particularly desirable to bring the water to a temperature that is hot, yet not boiling. A temperature range found particularly useful is from about 160° F. to about 180° F. Once the desired temperature is reached, soy protein isolate in dry powder form is added to the water. In specific embodiments of the present invention, approximately 9g of 68% soy protein isolate is added. As is known by those within the art, soy protein isolate is a highly refined or purified form of soy protein with a minimum protein content of 90% on a moisture-free basis. It is made from defatted soy flour which has had most of the non-protein components, fats and carbohydrates removed.

After mixing, and optionally heating the water, an acidic solution is added to the soy protein suspension to bring the pH of the solution to a level that is at or below the isoelectric charge point of the protein (i.e., a pH level at which the solution carries no net electrical charge). Here, the pH of the solution is desirably brought down to an acidic pH range between approximately about 3.5 to about 4.2. By bringing the pH down to this level, an acidified soy protein suspension is formed. One particularly useful and environmentally safe acidic solution that can be used for this purpose is vinegar. While the acetic acid concentration of the vinegar can vary depending on the type of vinegar used, it is particularly desirable to use a vinegar solution that has an acetic acid concentration ranging from about 4% to about 8% by volume. In specific exemplary embodiments, about 45 mL of vinegar having an acetic acid concentration of 5% by volume is added to the water.

After the acidic solution is added, the mixture is allowed to sit for an amount of time sufficient to cause the pH of the solution to lower as explained above. For instance, in certain embodiments of the present invention, the mixture is allowed to sit for about 5 minutes. Once the pH level has been adjusted accordingly, the mixture is filtered to extract the formed acidified soy protein suspension. When mixed in the illustrative amounts explained above, about 50 grams of soy protein suspension is produced.

Once the soy protein suspension has been extracted from the mixture, a sufficient amount of protein filler is added. Before adding the protein filler, however, the pH of the soy protein suspension is optionally adjusted so that it reaches a more pH neutral level. More particularly, since the final disc products will likely be introduced to the outside environment during use, it is desirable that they have a neutral pH level so as not to negatively impact the surrounding landscape. To accomplish this, the mixture can be optionally subjected to a neutralization reaction, in which an acid and a base, or alkali (soluble base), react to produce salt and water (H₂O). One illustrative neutralizing agent that can be used in accordance with the present invention is sodium bicarbonate or sodium hydrogen carbonate (baking soda). As those within the chemical industry clearly understand, adding sodium bicarbonate to a weak acidic solution such as vinegar causes an endothermic neutralization reaction to occur, the endothermic neutralization reaction causing thermal energy (heat) to be converted into chemical bond energy.

In a specific embodiment in accordance with the illustrative amounts explained above, 9 grams of baking soda are added to the mixture to balance the pH. More particularly, by adding the baking soda, the pH of the mixture is raised to a pH level of from about 7 to about 10. In specific embodiments, the pH level is raised to a level of from about 8 to about 10, more specifically from about 9 to about 9.8.

Once the pH of the soy protein suspension has been adjusted accordingly, a sufficient amount of protein filler is added to the suspension. While it is envisioned that various types of protein fillers may be used in accordance with the present invention, one exemplary protein filler is soybean meal. As is known by those within the art, soybean meal is the product obtained by grinding the soybean flakes that remain after removing (through a solvent or mechanical extraction process) most of the oil from soybeans. While varying proportions of protein filler to soy protein suspension can be formulated in accordance with the present teachings, in certain embodiments, a 1:1 ratio of protein filler to soy protein suspension is used. In other embodiments, the ratio of protein filler to soy protein suspension can be 1:2 or 2:1. It should be understood and appreciated herein that changing the ratio of filler to suspension impacts the fragility and/or structural characteristics of the resulting discs. As such, depending on the desired structural characteristics of the discs (e.g., how easily the manufacturer wants them to break during use), the proportional ratio of the ingredients can be altered as needed. However, the present inventors have found that a 1:1 ratio of filler to suspension is particularly useful, as well as cost efficient from a production standpoint, particularly as the ingredients used to make the soy protein suspension are more expensive than that of the soybean meal.

Before adding the protein filler to the suspension, it is helpful to grind it down into a fine powder consistency (e.g., around the consistency of all-purpose flour). Any instrument sufficient for reducing the particle size of the filler through attrition and compressive forces can be used in accordance with the present invention. One specific instrument useful for grinding the protein filler is a blade grinding machine, such as a coffer grinder.

Another exemplary protein filler that may be used in accordance with the present invention is zein, which is a class of prolamine protein found in maize and is usually manufactured as a powder from corn gluten meal. Still other protein fillers are also envisioned to be useful in accordance with the present invention without straying from the principles or teachings disclosed herein.

In embodiments in which the protein suspension is mixed with soybean meal as the protein filler, and is mixed in accordance with the illustrative amounts explained above, approximately 110 grams of a soy-based mixture or dough is produced. This soy-based mixture is now ready to be poured into a mold and formed into the disc. The mold may be constructed of any suitable material that allows heat to be evenly transferred into the mixture to cause heating of the same. One such exemplary mold is constructed from a metallic material, such as aluminum. In accordance with this illustrative embodiment, two pieces of aluminum (i.e., a top piece and a bottom piece) are constructed such that they can be placed on top of one another and completely surround the soy-based mixture when fitted together. Since the discs are intended to function as skeet targets (clay pigeons), it is desirable to mold them into a shape and size that dimensionally compares with that of conventional targets, as well as fits into and operates with conventional target throwing equipment. In addition, the targets must have sufficient structural strength to withstand being propelled in the air by the conventional target throwing equipment.

Before explaining the molding process in detail, it should be noted that the mixture may undergo some shrinkage during the heating process. As such, those of skill in the art will understand and appreciate that the actual dimensions of the mold may need to be adjusted to account for such shrinkage.

Moving now to an illustrative embodiment describing the molding process of the present invention, the mixture is poured into one half of the metallic mold, and then the other half is fitted onto the first half to completely enclose the mixture. After enclosing the mixture in the mold, the mold is encased with an outer covering designed to make sure the mixture is heated evenly throughout the heating process. In other words, the outer covering allows the metallic mold to heat the mixture by a conduction process, rather than by a convection process (i.e., from air within the oven). In addition, the outer covering allows the mixture to breathe so that air can escape from the mold, thereby eliminating unwanted moisture. In specific illustrative embodiments in accordance with the present invention, the outer covering can be made from a fiberglass and/or graphite material.

The oven is preheated to a temperature of about 232° C. (about 450° F.), and then the mold is placed into the oven to cause the proteins within the mixture to crosslink as the water is removed. In accordance with a specific embodiment, the mold is left in the oven for about 40 minutes. After 40 minutes, the mold is removed from the oven, and the mixture weighed. The mixture, which is now in the form of a hardened disc, weighs approximately 70 g and slightly shrinks in size as a result of the water being removed from the mixture.

As the resulting discs are made from 100% natural ingredients, they do not negatively impact the surrounding environment. In fact, when submerged in water, tests indicate that the discs are not acidic in nature, and actually even produce a byproduct that exhibits a basic pH level. This basic byproduct is a result of the neutralizing agent (e.g., sodium bicarbonate) being added to the mixture during its production. From these testes, the present inventors are able to conclude that it is possible to actually create a pH neutral environment by slightly adjusting the amount of neutralizing agent within the mixture. This is certainly a beneficial characteristic of the present discs, particularly as neutralizing the pH level can ensure that the surrounding environment will not be negatively impacted or harmed upon being exposed to the discs during use. As such, the present invention has the added benefit of not only being biodegradable, but also being environmentally friendly.

It should also be mentioned herein that as the present discs are made from environmentally safe and natural ingredients, they will also not harm wildlife if consumed.

Further advantages and improvements of the discs and associated processes and methods of manufacturing the discs in accordance with the present invention are demonstrated in the following descriptive example. This example is illustrative only and is not intended to limit or preclude other variants or aspects of the present invention.

### Example of Product Composition and Properties

| Material | Amount (per disc) | |
|---|---|---|
| Acetic Acid | 2.25 | g |
| Water | 42.75 | g |
| Sodium Bicarbonate | 9 | g |
| Soy Protein Isolate | 9 | g |
| Soy Meal | 50 | g |

Breakability of Disc: Using a 1,000 lb (4448 N) load cell on a SIMTech force analyzer, a comparison of the breakability of the present discs to that of conventionally manufactured discs was performed. The average amount of force required to break a conventional clay pigeon disc was 131.3 N, while the amount of force required to beak the present discs was 169.4 N. The extra force required to break the inventive discs is likely attributable to a slightly thicker width of these discs as compared to that of the conventional discs. It should also be noted that the disc used in this illustrative experiment had about 78% soy protein isolate in the overall product composition. This protein content is slightly higher than the 68% soy protein isolate that was used in other aspects of the invention as described above. The increase in protein was believed to impact the firmness/hardness of the disc and may have contributed to the increased amount of force required to break the disc during testing. Finally, it should also be noted that the discs manufactured in accordance with the present invention were considered broken after being impacted by three BB pellets. As will be understood by those of skill in the shooting art, three BB pellets are typically required to break a conventional clay pigeon target and/or to bring down most flying animal targets, such as birds.

PH Study: 12.5 g of a disc manufactured in accordance with the present invention was placed in 500 mL of water. The disc was exposed to the water for 48 hours, which caused it to swell and break-up, which in turn, caused some discoloration of the water. The pH of the discolored water was tested and found to be about 9.8. It was determined that the pH level was impacted by the addition of the sodium bicarbonate to the ingredients during the manufacture of the disc. By reducing the amount of sodium bicarbonate within the mixture, it is believed that the final pH level of the discs can be brought closer to a pH neutral level, or about a pH of 7.

Dissolvability of Disc: 12.5 g of a disc manufactured in accordance with the present invention was placed in 500 mL of water. The disc was exposed to the water for 48 hours, which caused it to swell and break-up, which in turn, caused some discoloration to the water. After 48 hours, the disc was removed from the water and allowed to dry. The weight of the disc pieces was 11.8 g, which is a 5.6% reduction over the two day period. When extrapolated out, this test indicates that the disc is capable of substantially dissolving in approximately 35.7 days if exposed to similar conditions within the outside environment.

While an exemplary embodiment incorporating the principles of the present invention has been disclosed hereinabove, the present invention is not limited to the disclosed embodiments. Instead, this application is intended to cover any variations, uses, or adaptations of the invention using its general principles. Further, this application is intended to cover such departures from the present disclosure as come within known or customary practice in the art to which this invention pertains and which fall within the limits of the appended claims.

REFERENCES: The following references are incorporated herein by reference in their entirety:

1. 2001 National Survey of Fishing, Hunting, and Wildlife-Associated Recreation U.S. Fish & Wildlife Services, October 2002.

2. Baer, K. N., D. G. Hutton, R. L. Boeri, T. J. Ward, and R. G. Stahl, Jr. 1995. “Toxicity evaluation of trap and skeet shooting targets to aquatic test species,” Ecotoxicol. 4: 385-392.

3. Chipley, Abigail. April, 2000. “Edible Plastic?—Biodegradable Soy Plastic,—Brief Article,” Vegetarian Times.

4. “Clay Pigeon Shooting: Your Guide to the History of Clay Pigeon Shooting,” World Sporting. Accessed Mar. 5, 2008.

5. Lobb, Andrea J. “Potential for PAH Contamination from Clay Target Debris at Shooting Sites: Review of Literature on Occurrence of Site Contamination from Clay Targets,” June 2006.

6. Wescott, Trska et al. “Durable Soy-Based Adhesive Dispersions,” Wood adhesives 2005: Nov. 2-4, 2005, pages 263-269.

7. “White Flyer is Sensitive to Environmental Issues,” Biodegradable Targets, Accessed October 2007—http://www.whiteflyer.com/targetbio.html.

What is claimed is:

1. A biodegradable target disc, comprising:
soy protein isolate; and
a protein filler;
wherein the target disc is adapted to be molded into a rigid target that is launchable from a launching device.

2. The biodegradable target disc of claim 1, wherein the protein filler comprises soybean meal.

3. A process for manufacturing a biodegradable target disc, comprising:
forming a mixture containing soy protein isolate, water and an acidic solution;
extracting an acidified soy protein suspension from the mixture;
adding a protein filler to the acidified soy protein suspension to form a dough;
pouring the dough into a mold;
heating the dough inside the mold to form a rigid target disc; and
removing the rigid target disc from the mold.

4. The process of claim 3, wherein the acidic solution is vinegar.

5. The process of claim 4, wherein the vinegar has an acetic acid concentration of from about 4% to about 8% by volume.

6. The process of claim 3, wherein the protein filler is soybean meal.

7. The process of claim 3, further comprising heating the water to a temperature of from about 160° F. to about 180° F. before forming the mixture.

8. The process of claim 3, further comprising adjusting the pH of the acidified soy protein suspension before adding the protein filler.

9. The process of claim 8, wherein adjusting the pH of the acidified soy protein suspension comprises adding a neutralizing agent to the suspension.

10. The process of claim 9, wherein the neutralizing agent is sodium bicarbonate.

11. The process of claim 3, wherein the ratio of protein filler to soy protein suspension is 1:1.

12. The process of claim 3, further comprising grinding the protein filler down to a fine powder consistency before adding it to the acidified soy protein suspension.

13. The process of claim 3, wherein the protein filler comprises a prolamine protein.

14. The process of claim 13, wherein the prolamine protein is zein.

15. The process of claim 3, wherein the mold comprises a metallic mold.

16. The process of claim 15, wherein the metallic mold comprises aluminum.

17. The process of claim 3, wherein the heating step is conducted at a temperature of about 450° F. and for around about 40 minutes.

18. A biodegradable target disc adapted to be molded into a rigid target that is launchable from a launching device, comprising:
a binder material formed from a mixture of soy protein isolate, water and vinegar; and
a protein filler including soybean meal;
wherein the ratio of binder material to protein filler is 1:1.

19. The biodegradable target disc of claim 18, further comprising a neutralizing agent.

20. The biodegradable target disc of claim 19, wherein the neutralizing agent comprises sodium bicarbonate.
